(19) United States
(12) Patent Application Publication
(10) Pub. No.: US 2014/0287213 A1
(43) Pub. Date: Sep. 25, 2014

(54) COVER WINDOW FOR DISPLAY DEVICE, DISPLAY DEVICE COMPRISING THE SAME, AND METHOD FOR MANUFACTURING THE SAME

(71) Applicants: Kyu-Taek Lee, Yongin-City (KR); Hak-Sun Kim, Yongin-City (KR); Tae-Hyeog Jung, Yongin-City (KR); Kyu-Young Kim, Yongin-City (KR)

(72) Inventors: Kyu-Taek Lee, Yongin-City (KR); Hak-Sun Kim, Yongin-City (KR); Tae-Hyeog Jung, Yongin-City (KR); Kyu-Young Kim, Yongin-City (KR)

(21) Appl. No.: 13/956,288

(22) Filed: Jul. 31, 2013

(30) Foreign Application Priority Data
Mar. 20, 2013 (KR) 10-2013-0029941

(51) Int. Cl. G02F 1/1333

(52) U.S. Cl. CPC G02F 1/133308
USPC 428/217; 427/558

(57) ABSTRACT

A cover window for a display device which is bendable and having more than a certain degree of surface hardness, the cover window including a base film and a coating layer on the base film, the coating layer including first and second regions including different degrees of hardness.

### CROSS-REFERENCE TO RELATED APPLICATION

This application claims priority to and the benefit of Korean Patent Application No. 10-2013-0029941, filed in the Korean Intellectual Property Office on Mar. 20, 2013, the entire content of which is incorporated herein by reference.

### BACKGROUND

1. Technical Field

Embodiments of the present invention relate to a cover window for a display device, a display device including the same, and a method for manufacturing the same.

2. Description of the Related Art

Recently, various mobile electronic devices, such as cellular phones, navigation devices, digital cameras, electronic books, portable game machines, and/or various terminals employing liquid crystal displays (LCDs) or organic light emitting diodes (OLED) as display devices, are in use.

General display devices used in mobile devices include a transparent cover window provided in a front side of a display panel to allow a user to view a display unit therethrough. The cover window is a component configured in the outermost side of a device, and can be resistant to external impact to protect a display panel, and the like, within the device.

In addition, recently, the scheme of using a touch panel integrally formed with a display screen, instead of a conventional scheme in which a switch or a keyboard is used as an input device, has become prevalent, wherein a surface of a cover window comes frequently into contact with a user's finger, or the like, requiring the cover window to have a higher degree of strength.

Also, recently, research into a flexible display device has been actively conducted, and a cover window applied to such a flexible display device that is configured as a bendable flexible member may be of interest. However, strength and flexibility of a cover window are in a trade-off relationship, making it difficult to implement both characteristics.

The above information disclosed in this Background section is only for enhancement of understanding of the background of the invention and therefore it may contain information that does not form the prior art that is already known in this country to a person of ordinary skill in the art.

### SUMMARY

Aspects of the embodiments of the present invention provide a cover window for a display device having aspects such as being bendable/flexible and having more than a certain degree of surface hardness, a display device including the same, and a method for manufacturing the same.

According to an embodiment of the present invention, there is provided a cover window for a display device, the cover window including: a base film; and a coating layer on the base film, the coating layer including first and second regions including different degrees of hardness.

The second region may be more flexible than the first region.

The first region may include a hard member, and the second region may include a soft member.

The first region may include a hard member, and the second region may include alternately arranged hard and soft members.

An entirety of the first region may include a hard member, and the second region may include hard members including a plurality of bar-like shapes, the hard members defining openings respectively between the hard members.

An entirety of the first region may include a hard member, and the second region may include hard members including a plurality of island-like shapes, the hard members defining openings respectively between the hard members.

The openings may include a grid of openings.

According to another embodiment of the present invention, there is provided a display device including: a display panel; and a cover window on the display panel, wherein the cover window includes: a base film; and a coating layer on the base film, the coating layer including first and second regions including different degrees of hardness.

The first region may include a hard member, and the second region includes a soft member.

The first region may include a hard member, and second region includes alternately arranged hard and soft members.

An entirety of the first region may include a hard member, and the second region may include hard members including a plurality of bar-like shapes, the hard members defining openings therebetween.

An entirety of the first region may include a hard member, and the second region may include hard members including a plurality of island-like shapes, the hard members defining openings therebetween.

According to another embodiment of the present invention, there is provided a method for manufacturing a cover window for a display device, the method including: forming a coating layer on a base film; placing a mask including a light-transmissive portion and a semi-light-transmissive portion above the coating layer; and radiating ultraviolet light to cure the coating layer.

The radiating the ultraviolet light to cure the coating layer may cause: a first portion of the coating layer corresponding to the light-transmissive portion of the mask to become a hard member; and a second portion of the coating layer corresponding to the semi-light-transmissive portion of the mask to become a soft member.

The mask may include one or more regions in which parts of the light-transmissive portion and the semi-light-transmissive portion are alternatively positioned.

According to an embodiment of the present invention, there is provided a method for manufacturing a cover window for a display device, the method including: forming a coating layer on a base film; patterning the coating layer to form openings; and radiating ultraviolet light onto the coating layer to cure the coating layer.

The openings may include bar-like shapes.

The openings may have a grid form.

The cover window for a display device, the display device including the same, and the method for manufacturing the same according to embodiments of the present invention have the following aspects.

The cover window which is bendable and has more than a preset (or predetermined) degree of surface hardness can be implemented by forming the coating layer having portions having different degrees of hardness on the base film.

### BRIEF DESCRIPTION OF THE DRAWINGS

FIG. 1 is an exploded perspective view of a display device, according to a first example embodiment of the present invention.

FIG. 2 is a perspective view illustrating a portion of a cover window of the display device, according to the first example embodiment of the present invention.

FIGS. 3 and 4 are cross-sectional views illustrating a sequential process of a method for manufacturing the cover window of the display device, according to the first embodiment of the present invention.

FIG. 5 is a perspective view illustrating a portion of a cover window of a display device, according to a second example embodiment of the present invention.

FIGS. 6 and 7 are cross-sectional views illustrating a sequential process of a method for manufacturing the cover window of the display device, according to the second embodiment of the present invention.

FIG. 8 is a perspective view illustrating a portion of a cover window of a display device, according to a third example embodiment of the present invention.

FIG. 9 is a perspective view illustrating a portion of a cover window of a display device, according to a fourth example embodiment of the present invention.

### DETAILED DESCRIPTION

Hereinafter, embodiments of the present invention will be described more fully hereinafter with reference to the accompanying drawings, in which example embodiments of the invention are shown. As those skilled in the art would realize, the described embodiments may be modified in various ways without departing from the spirit or scope of the present invention.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or one or more intervening elements may also be present. In contrast, when an element is referred to as being “directly on” another element, there are no intervening elements present.

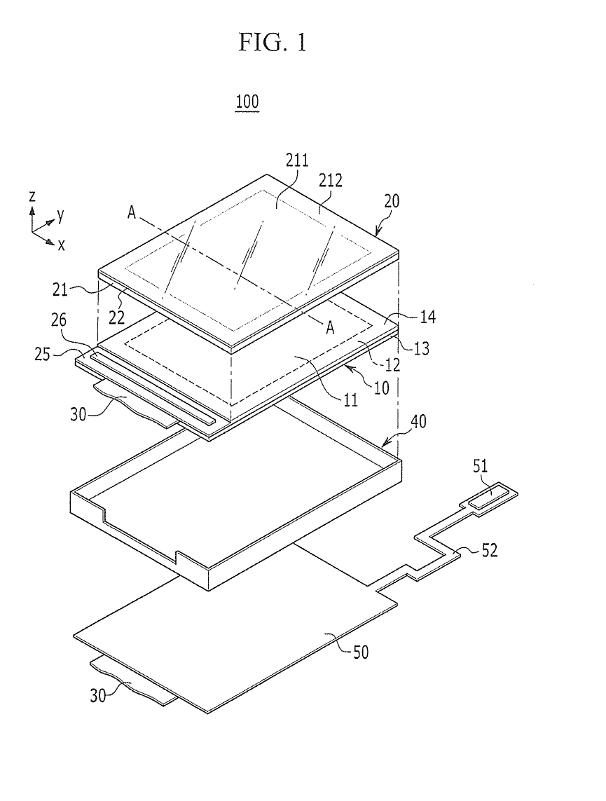

First, a display device according to a first embodiment of the present invention will be described with reference to FIG. 1. FIG. 1 is an exploded perspective view of a display device, according to a first embodiment of the present invention. Referring to FIG. 1, the display device 100 according to the first embodiment of the present invention includes a display panel 10 for displaying an image, a housing 40 accommodating the display panel 10 and various components, and a cover window 20 positioned in front of the display panel 10 to protect the display panel 10.

The display panel 10 may be an organic light emitting display panel. Alternatively, the display panel 10 may be a display panel other than an organic light emitting display panel (e.g., a liquid crystal display panel). In the present embodiment, an organic light emitting display panel will be described as an example, but the present invention is not limited thereto.

The display panel 10 is electrically connected to a printed circuit board (PCB) 50 through a flexible printed circuit 30.

Pixels, which are basic units for expressing an image, are arranged in a matrix on a first substrate 13 of the display panel 10, and a second substrate 14 is bonded to the first substrate 13 through a sealing member to protect the pixels. The first substrate 13 may be a rear substrate, and the second substrate 14 may be a front substrate.

For example, in an active matrix organic light emitting display panel, each pixel includes an organic light emitting element including an anode electrode, an organic light emitting layer, and a cathode electrode, and a driving circuit unit for driving the organic light emitting element. The driving circuit unit may be a thin film transistor (TFT). A data line is electrically connected to a source terminal of the TFT, and a gate line is electrically connected to a gate terminal of the TFT. Any one of the anode electrode and the cathode electrode of organic light emitting element is electrically connected to a drain terminal of the TFT.

The data line and the gate line are electrically connected to the PCB 50 through the flexible printed circuit 30. When an electrical signal is input to the source terminal and the gate terminal of the TFT through the PCB 50, the TFT is turned on or off, according to the signal input, to output an electrical signal for driving pixels to the drain terminal.

An integrated circuit (IC) chip 26 is mounted on the first substrate 13 to control the display panel 10. The IC chip 26 may generate timing signals for applying a data driving signal and a gate driving signal at an appropriate time, and may apply the generated timing signals to the data line and the gate line of the display panel 10, respectively. A protective layer 25 is formed around the IC chip 26 to protect the IC chip 26.

Electronic elements for processing driving signals are mounted on the PCB 50. The PCB 50 includes a connector 51 and an extending part 52. The extending part 52 is installed at one end of the connector 51 to transmit an external signal to the PCB 50.

The cover window 20 protecting the display panel 10 may be positioned in front of the display panel 10, and may protect the display panel 10 such that the display panel 10 is not broken due to external impact. The cover window 20 may be attached to the display panel 10 by means of a bonding layer (e.g., a predetermined bonding layer). Alternatively, the display panel 10 and the cover window 20 may be spaced from one another with an air layer formed therebetween. The cover window 20 includes a base film 21 and a coating layer 22 formed on the base film 21.

The base film 21 includes a transparent part 211 that is transparent in a region corresponding to a display part 11, which allows the display unit 11 to be externally visible, and an opaque part 212 that is opaque in a region corresponding to a non-display part 12 of the display panel 10 to prevent the non-display part 12 from being externally visible. The opaque part 212 may cover (or shroud) a wiring, a component, and the like, which are formed in the non-display part 12 of the display panel 10 such that they are not seen when the display panel 10 is in use. The opaque part 212 may include a logo of a product, a decorative pattern, and/or the like.

The base film 21 may be made of, for example, polyethyleneterephthalate (PET), a triacetyl cellulose (TAC), polyimide (PI), polycarbonate (PC), thermoplastic polyurethane (TPU), silicon rubber, and/or the like.

The coating layer 22 is coated on the base film 21, and may include portions having different degrees of hardness, which will be described in detail hereinafter.

The coating layer 22 may be formed through, for example, acrylic hard coating or organic/inorganic hybrid hard coating.

The display device 100, according to an embodiment, may be made of a flexible material/a material that can be bent. For example, the display device 100 may be bent along the line A-A, and accordingly, the cover window 20 may also be bent along the line A-A.

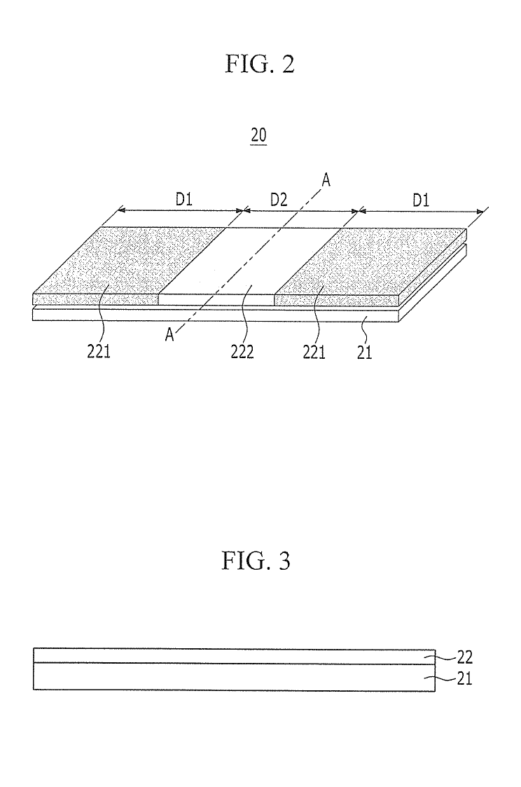

Hereinafter, referring to FIG. 2, the cover window 20 of the display device 100, according to the first embodiment of the present invention, will be described with reference to FIG. 2. FIG. 2 is a perspective view illustrating a portion of the cover window of the display device, according to the first example embodiment of the present invention. As illustrated in FIG. 2, the cover window 20 may include the base film 21 and the coating layer 22 formed on the base film 21.

The coating layer 22 includes first regions D1 and a second region D2, and the first regions D1 and the second region D2 have different degrees of hardness. The second region D2 is between the two first regions D1 and corresponds to line A-A along which the display device 100 may be bent. The second region D2 is more flexible than/formed to be bent more easily than the first regions D1, and the first regions D1 are formed to be harder than second region D2. Thus, when the display device 100 is bent along line A-A, the cover window 20 may also be bent. Also, because the first regions D1 are hard, they may serve to reliably protect the display panel 10.

The first regions D1 of the coating layer 22 are configured as hard members 221, while the second region D2 of the coating layer 22 is configured as a soft member 222. Here, the entirety of the first regions D1 may be configured as the hard members 221, while the entirety of the second region D2 may be configured as the soft member 222.

The hard members 221 may be made of a material having a higher degree of hardness than that of the soft member 222, and may be capable of being bent. In this embodiment, however, the soft member 222 may be more easily bent than the hard members 221.

Because the cover window 20 of the display device, according to the first embodiment of the present invention, includes the coating layer 22 including portions having different degrees of hardness formed on the base film 21, it can be bent and have more than a certain degree (e.g., a preset or predetermined level) of surface hardness. Namely, the first regions D1 of the coating layer 22 mainly serve to bend the display panel 10, rather than to protect the display panel 10, and the second region D2 mainly serves to protect the display panel 10, rather than to bend the display panel 10.

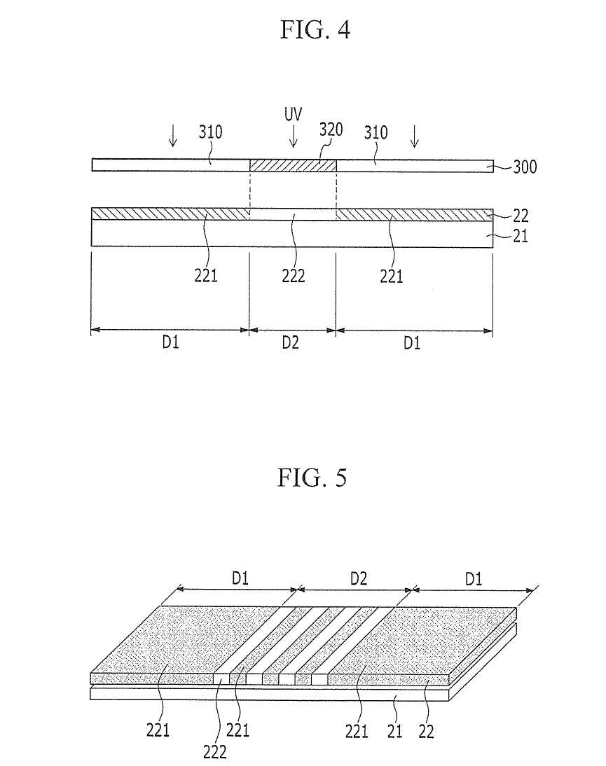

Hereinafter, a method for manufacturing the cover window 20 of the display device, according to an embodiment of the present invention, will be described with reference to FIGS. 3 and 4.

FIGS. 3 and 4 are cross-sectional views illustrating a sequential process of a method for manufacturing a cover window of a display device, according to an example embodiment of the present invention.

First, as illustrated in FIG. 3, the base film 21 is formed with polyethyleneterephthalate (PET), a triacetyl cellulose (TAC), polyimide (PI), polycarbonate (PC), thermoplastic polyurethane (TPU), silicon rubber, and/or the like.

Next, the coating layer 22 is formed on the base film 21 by, for example, using an acrylic hard coating process or an organic/inorganic hybrid hard coating process.

As illustrated in FIG. 4, a mask is placed above the coating layer 22, and ultraviolet (UV) light is radiated to cure the coating layer 22.

The mask 300 includes light-transmissive portions 310 and a semi-light-transmissive portion 320. UV light radiated onto the light-transmissive portions 310 of the mask 300 mostly passes through the mask 300. Meanwhile, a partial amount of UV light radiated onto the semi-light-transmissive portion 320 of the mask 300 passes through the mask 300, while the remaining amount of UV light not passing through the mask 300 is absorbed by, or potentially reflected by, the mask 300.

The light-transmissive portions 310 correspond to the first regions D1 of the coating layer 22, while the semi-light-transmissive portion 320 of the mask 300 corresponds to the second region D2 of the coating layer 22. A large amount of UV light is radiated onto the first regions D1 of the coating layer 22, relative to the second region D2. Thus, the first regions D1 are cured to be harder than the second region D2, so the first regions D1 become hard members and the second region D2 becomes a soft member.

Namely, in the cover window 20 of the display device, according to the present embodiment of the present invention, the same material is coated to form the coating layer 22, and the first regions D1 and the second region D2 of the coating layer 22 are subsequently cured under different conditions, whereby the coating layer 22 may include regions having different degrees of hardness.

Hereinafter, a cover window of the display device according to a second embodiment of the present invention will be described with reference to FIG. 5. FIG. 5 is a perspective view illustrating the portion of the cover window of the display device, according to the second embodiment of the present invention. The cover window of the display device of the present embodiment is similar to the cover window of the display device according to the aforementioned embodiment, so common descriptions of the same components will be not be repeated, and only differences from the first embodiment will be described. A difference between the cover window of the display device of the second embodiment from the first embodiment is that the second region D2 of the coating layer includes a hard member and a soft member, which will be described in detail, hereinafter.

As illustrated in FIG. 5, the cover window 20 of the display device, according to the second embodiment of the present invention, includes the base film 21, and the coating layer 22 formed on the base film 21.

The coating layer 22 includes the first regions D1 and the second region D2, and the first regions D1 and the second region D2 have different degrees of hardness. The second region D2 of the coating layer 22 is more easily bent than the first regions D1, and the first regions D1 are formed to be harder than the second region D2.

The first regions D1 of the coating layer 22 are configured as the hard members 221, and the second region D2 includes the hard member(s) 221 and the soft member(s) 222. Here, the first regions D1 may be entirely formed of the hard members 221, and the second region D2 may include the hard member(s) 221 and the soft member(s) 222 alternately positioned. Because the soft member 222 and the hard member 221 are formed together in the second region D2, the second region D2 is more flexible/more easily bent than the first regions D1, which are formed of only the hard member 221.

The hard member(s) 221 and the soft member(s) 222 positioned in the second region D2 may have a bar-like shape (e.g., appearing as a striped pattern), and the hard member 221 and the soft member 222 having a bar-like shape may have the same width or similar widths.

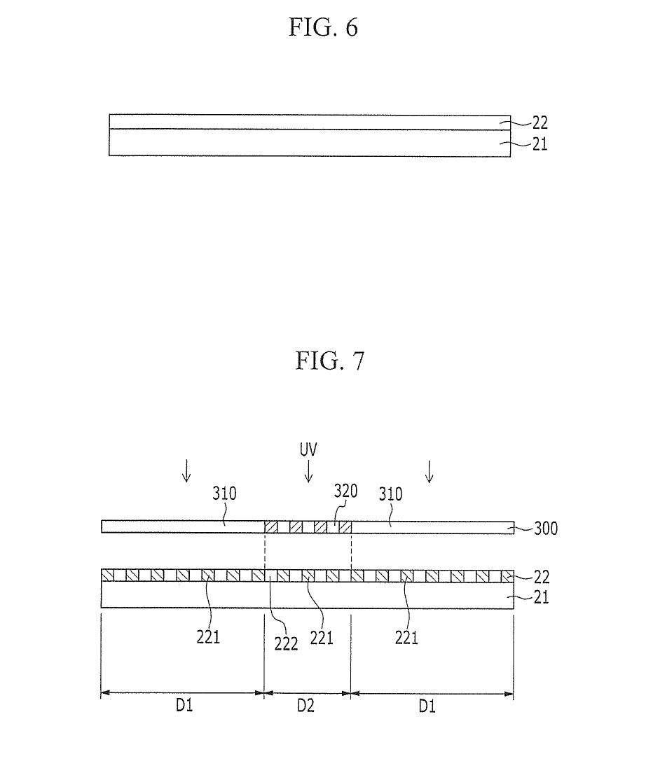

Hereinafter, a method for manufacturing the cover window 20 of the display device, according to the second embodiment of the present invention, will be described with reference to FIGS. 6 and 7. FIGS. 6 and 7 are cross-sectional views illustrating a sequential process of a method for manufacturing the cover window of the display device.

First, as illustrated in FIG. 6, the coating layer 22 is formed on the base film 21 by, for example, using an acrylic hard coating process or an organic/inorganic hybrid hard coating process.

As illustrated in FIG. 7, a mask is placed above the coating layer 22, and ultraviolet light (UV) is radiated to cure the coating layer 22. The mask 300 includes the light-transmissive portions 310 and the semi-light-transmissive portion 320.

The coating layer 22 includes the first regions D1 and the second region D2. Portions of the mask 300 corresponding to the first regions D1 of the coating layer 22 are formed of the light-transmissive portions 310. Portions of the mask 300 corresponding to the second region D2 includes the light-transmissive portion 310 and the semi-light-transmissive portion 320, and the light-transmissive portion 310 and the semi-light-transmissive portion 320 may be alternately located. The light-transmissive portion 310 and the semi-light-transmissive portion 320 of the mask 300 may have a bar-like shape (e.g., in the form of a striped pattern), and the light-transmissive portion 310 and the semi-light-transmissive portion 320 having a bar-like shape may have the same, or similar, widths.

According to an embodiment, a portion(s) of the coating layer 22 corresponding to the light-transmissive portion 310 of the mask 300 becomes a hard member(s), and a portion(s) of the coating layer 22 corresponding to the semi-light-transmissive portion 320 of the mask 300 becomes a soft member(s). For example, the first regions D1 of the coating layer 22 may be entirely formed of the hard members 221, and the second region D2 may include the hard member 221 and the soft member 222 alternately positioned. Because the soft member 222 and the hard member 221 are formed together in the second region D2, the second region D2 is more easily bent than the first regions D1 formed of only the hard member 221.

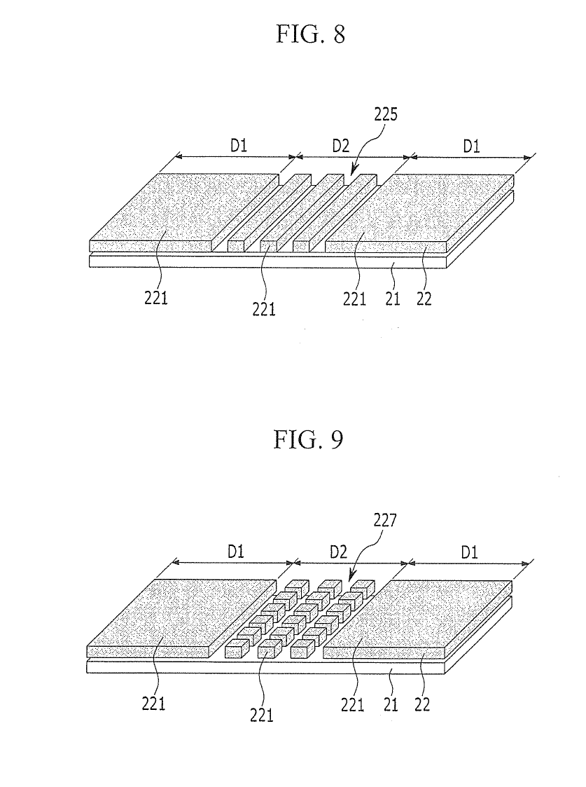

Hereinafter, a cover window of the display device, according to a third embodiment of the present invention, will be described with reference to FIG. 8. FIG. 8 is a perspective view illustrating the portion of the cover window of a display device.

The cover window of the display device, according to the third embodiment of the present invention is similar to the cover window of the display device according to the first embodiment of the present invention, so common descriptions of the same components will not be repeated, and differences will be described. A difference of the cover window of the display device according to the third embodiment of the present invention from that of the first embodiment is that the second region of the coating layer is configured as a hard member. This will be described in detail, hereinafter.

As illustrated in FIG. 8, the cover window 20 of the display device, according to an example embodiment of the present invention, includes the base film 21 and the coating layer 22 formed on the base film 21.

The coating layer 22 includes the first regions D1 and the second region D2, which have different degrees of hardness. The second region D2 of the coating layer 22 is more easily bent than the first regions D1, and the first regions D1 are formed to be harder than the second region D2.

In the present embodiment, the first regions D1 and parts of the second region D2 of the coating layer 22 are configured as the hard members 221. For example, the first regions D1 are entirely formed of the hard members 221, and the second region D2 is partially formed of the hard members 221. The hard members 221 of the second region D2 has a plurality of bar-like shapes, and openings 225 are formed between the hard members 221 (e.g., in a striped pattern). The openings 225 may also be configured as a plurality of bar-like shapes. A width of the hard members 221 having bar-like shapes may be equal, or similar, to that of the openings 225.

Because density of the hard members 221 in the second region D2 of the coating layer 22 is lower than that of the hard members 221 in the first regions D1, the second region D2 is more easily bent than the first regions D1.

Hereinafter, a method for manufacturing the cover window 20 of the display device, according to an example embodiment of the present invention will be described with reference to FIG. 8.

First, the coating layer 22 is formed on the base film 21 by using an acrylic hard coating process or an organic/inorganic hybrid hard coating process.

Next, the coating layer 22 is patterned to form the openings 225 in the second region D2 of the coating layer 22. The openings 225 may have a uniform width at uniform intervals, and may have a bar-like shape. The widths of the openings 225 and the intervals between the openings 225 may be equal or similar.

Subsequently, UV is radiated onto the entirety of the coating layer 22 to cure the coating layer 22. Portions of the coating layer 22, excluding the openings 225, become the hard members 221. Here, the hard members 221 positioned in the second region D2 may have a plurality of bar-like shapes (e.g., in the form of a striped pattern).

In the above description, the coating layer 22 is patterned and subsequently cured, but the present invention is not limited thereto. The coating layer 22 may be first cured and subsequently patterned.

Hereinafter, a cover window of the display device, according to a fourth embodiment of the present invention, will be described with reference to FIG. 9. FIG. 9 is a perspective view illustrating a portion of the cover window of the display device, according to the fourth embodiment.

The cover window of the display device, according to the fourth embodiment of the present invention, is similar to that of the third embodiment, and common descriptions of the same components will not be repeated here, and instead, differences will be described. A significant difference between the cover window of the display device of the present embodiment from that of the third embodiment is a configuration of the opening formed in the second region. This will be described in detail, hereinafter.

As illustrated in FIG. 9, the cover window 20 of the display device, according to the fourth embodiment of the present invention, includes the base film 21 and the coating layer 22 formed on the base film 21.

The coating layer 22 includes the first regions D1 and the second region D2, and the first regions D1 and the second region D2 have different degrees of hardness. The second region D2 of the coating layer 22 is more easily bent than the first regions D1, and the first regions D1 are formed to be harder than the second region D2.

The first regions D1 and the second region D2 of the coating layer 22 are, at least partially, formed of hard members 221. For example, the first regions D1 are entirely formed of the hard members 221, and the second region D2 is partially formed of the hard members 221.

The hard members 221 of the second region D2 have a plurality of island-like shapes. Openings 227 are formed between the hard members 221 having the plurality of island-like shape. The openings 227 may have a grid/matrix form. A width of the hard members 221 having an island-like shape may be equal, or similar, to that of the openings 227.

Because density of the hard members 221 in the second region D2 of the coating layer 22 is lower than that of the hard members 221 in the first regions D1, the second region D2 is more easily bent than the first regions D1.

Hereinafter, a method for manufacturing the cover window 20 of the display device of the fourth embodiment of the present invention will be described with reference to FIG. 9.

First, the coating layer 22 is formed on the base film 21 by using an acrylic hard coating process or an organic/inorganic hybrid hard coating process.

Next, the coating layer 22 is patterned to form the openings 227 in the second region D2 of the coating layer 22. The openings 227 may have a substantially uniform width at substantially uniform intervals, and may have a grid form or a matrix form. The widths of the openings 227 and the intervals between the openings 225 may be equal or similar.

Subsequently, UV is irradiated to the entirety of the coating layer 22 to cure the coating layer 22. Portions of the coating layer 22, excluding the openings 227, become the hard members 221. Here, the hard members 221 positioned in the second region D2 may have a plurality of island-like shapes.

In the above description, the coating layer 22 is patterned and subsequently cured, but the present invention is not limited thereto. The coating layer 22 may be first cured and subsequently patterned.

While embodiments of the present invention have been described in connection with what is presently considered to be practical example embodiments, it is to be understood that the invention is not limited to the disclosed embodiments, but, on the contrary, is intended to cover various modifications and equivalent arrangements included within the spirit and scope of the appended claims and equivalents thereof.

Description of Some of the Reference Characters:

| | |
|---|---|
| D1: first region | D2: second region |
| 10: display panel | 20: cover window |
| 21: base film | 22: coating layer |
| 30: flexible printed circuit | 40: housing |
| 50: flexible printed circuit (FPC) | 221: hard member |
| 222: soft member | 225, 227: opening |
| 300: mask | 310: light-transmissive portion |
| 320: semi-light-transmissive portion | |

What is claimed is:

1. A cover window for a display device, the cover window comprising:
a base film; and
a coating layer on the base film, the coating layer comprising first and second regions having different degrees of hardness.

2. The cover window of claim 1, wherein the second region is more flexible than the first region.

3. The cover window of claim 2, wherein the first region comprises a hard member, and
wherein the second region comprises a soft member.

4. The cover window of claim 2, wherein the first region comprises a hard member, and
Wherein the second region comprises alternately arranged hard and soft members.

5. The cover window of claim 2, wherein an entirety of the first region comprises a hard member, and
wherein the second region comprises hard members comprising a plurality of bar-like shapes, the hard members defining openings respectively between the hard members.

6. The cover window of claim 2, wherein an entirety of the first region comprises a hard member, and
wherein the second region comprises hard members comprising a plurality of island-like shapes, the hard members defining openings respectively between the hard members.

7. The cover window of claim 6, wherein the openings comprise a grid of openings.

8. A display device comprising:
a display panel; and
a cover window on the display panel,
wherein the cover window comprises:
a base film; and
a coating layer on the base film, the coating layer comprising first and second regions having different degrees of hardness.

9. The display device of claim 8, wherein the first region comprises a hard member, and
wherein the second region comprises a soft member.

10. The display device of claim 8, wherein the first region comprises a hard member, and
wherein the second region comprises alternately arranged hard and soft members.

11. The display device of claim 8, wherein an entirety of the first region comprises a hard member, and
wherein the second region comprises hard members comprising a plurality of bar-like shapes, the hard members defining openings therebetween.

12. The display device of claim 8, wherein an entirety of the first region comprises a hard member, and
wherein the second region comprises hard members comprising a plurality of island-like shapes, the hard members defining openings therebetween.

13. A method for manufacturing a cover window for a display device, the method comprising:
forming a coating layer on a base film;
placing a mask comprising a light-transmissive portion and a semi-light-transmissive portion above the coating layer; and
radiating ultraviolet light to cure the coating layer.

14. The method of claim 13, wherein, the radiating the ultraviolet light to cure the coating layer causes:
a first portion of the coating layer corresponding to the light-transmissive portion of the mask to become a hard member; and
a second portion of the coating layer corresponding to the semi-light-transmissive portion of the mask to become a soft member.

15. The method of claim 14, wherein the mask comprises one or more regions in which parts of the light-transmissive portion and the semi-light-transmissive portion are alternatively positioned.

16. A method for manufacturing a cover window for a display device, the method comprising:
forming a coating layer on a base film;
patterning the coating layer to form openings; and
radiating ultraviolet light onto the coating layer to cure the coating layer.

17. The method of claim 16, wherein the openings comprise bar-like shapes.

18. The method of claim 16, wherein the openings have a grid form.
